(19) United States
(12) Patent Application Publication
(10) Pub. No.: US 2023/0013421 A1
(43) Pub. Date: Jan. 19, 2023

(54) POINT CLOUD COMPRESSION USING OCCUPANCY NETWORKS

(71) Applicants: SONY GROUP CORPORATION, Tokyo (JP); Sony Corporation of America, New York, NY (US)

(72) Inventors: Danillo Graziosi, Flagstaff, AZ (US); Alexandre Zaghetto, San Jose, CA (US); Ali Tabatabai, Cupertino, CA (US)

(21) Appl. No.: 17/828,326

(22) Filed: May 31, 2022

Related U.S. Application Data
(60) Provisional application No. 63/221,552, filed on Jul. 14, 2021.

(51) Int. Cl. H04N 19/597; G06V 10/764; G06V 10/82; G06V 20/64; H04N 19/13; H04N 19/167; H04N 19/29; H04N 19/436; H04N 19/132

(52) U.S. Cl. CPC H04N 19/597; G06V 10/764; G06V 10/82; G06V 20/64; H04N 19/13; H04N 19/167; H04N 19/29; H04N 19/436; H04N 19/132; G06T 2207/20081; G06T 2207/20084; G06T 2210/56; G06T 2210/32

(57) ABSTRACT

Occupancy networks enable efficient and flexible point cloud compression. In addition to the voxel-based representation, occupancy networks are able to handle points, meshes, or projected images of 3D objects, making them very flexible in terms of input signal representation. The probability of occupancy of positions is estimated using occupancy networks instead of sparse convolutional neural networks. A compression implementation using occupancy network enables scalability with infinite reconstruction resolution.

### CROSS-REFERENCE TO RELATED APPLICATION(S)

This application claims priority under 35 U.S.C. § 119(e) of the U.S. Provisional Patent Application Ser. No. 63/221,552, filed Jul. 14, 2021 and titled, “POINT CLOUD COMPRESSION USING OCCUPANCY NETWORKS,” which is hereby incorporated by reference in its entirety for all purposes.

### FIELD OF THE INVENTION

The present invention relates to three dimensional graphics. More specifically, the present invention relates to coding of three dimensional graphics.

### BACKGROUND OF THE INVENTION

Recently, point clouds have been considered as a candidate format for transmission of 3D data, either captured by 3D scanners, LIDAR sensors, or used in popular applications such as VR/AR. Point clouds are a set of points in 3D space.

Besides the spatial position (x, y, z), each point usually have associated attributes, such as color (R, G, B) or even reflectance and temporal timestamps (e.g., in LIDAR images).

In order to obtain a high fidelity representation of the target 3D objects, devices capture point clouds in the order of thousands or even millions of points.

Moreover, for dynamic 3D scenes used in VR/AR application, every single frame often has a unique dense point cloud, which result in the transmission of several millions of point clouds per second. For a viable transmission of such large amount of data compression is often applied.

In 2017, MPEG had issued a call for proposal (CfP) for compression of point clouds. After evaluation of several proposals, currently MPEG is considering two different technologies for point cloud compression: 3D native coding technology (based on octree and similar coding methods), or 3D to 2D projection, followed by traditional video coding.

With the conclusion of G-PCC and V-PCC activities, the MPEG PCC working group started to explore other compression paradigms, which included machine learning-based point cloud compression.

Occupancy networks implicitly represent the 3D surface as the continuous decision boundary of a deep neural network classifier. The representation encodes a description of the 3D output at infinite resolution.

More recently, spatially sparse convolution neural networks were applied to lossless and lossy geometry compression, with additional scalable coding capability.

### SUMMARY OF THE INVENTION

Occupancy networks enable efficient and flexible point cloud compression. In addition to the voxel-based representation, occupancy networks are able to handle points, meshes, or projected images of 3D objects, making them very flexible in terms of input signal representation. The probability of occupancy of positions is estimated using occupancy networks instead of sparse convolutional neural networks. A compression implementation using occupancy network enables scalability with infinite reconstruction resolution.

In one aspect, a method programmed in a non-transitory memory of a device comprises receiving a bitstream at one or more occupancy networks, determining a probability of a position in the bitstream being occupied with the one or more occupancy networks and generating a function based on the probability of positions being occupied. The bitstream comprises voxels, points, meshes, or projected images of 3D objects. The bitstream comprises one or more samples of a 3D space to be used to generate a 3D object with the one or more occupancy networks. The probability is determined using machine learning to implement implicit neural functions. The one or more occupancy networks implicitly represent 3D surfaces using a continuous decision boundary based on a deep neural network classifier, and decides based on a threshold whether data belongs inside or outside a 3D structure. The probability is determined based neighboring position classification information. The probability is used by an entropy encoder to define a code length of an occupancy code of points in 3D space. The one or more occupancy networks learn the function to recover a specific shape based on a sparse input. The function represents a set of classes, and an object is recovered based on an input. A size of the function is smaller than the bitstream.

In another aspect, an apparatus comprises a non-transitory memory for storing an application, the application for: receiving a bitstream at one or more occupancy networks, determining a probability of a position in the bitstream being occupied with the one or more occupancy networks and generating a function based on the probability of positions being occupied and a processor coupled to the memory, the processor configured for processing the application. The bitstream comprises voxels, points, meshes, or projected images of 3D objects. The bitstream comprises one or more samples of a 3D space to be used to generate a 3D object with the one or more occupancy networks. The probability is determined using machine learning to implement implicit neural functions. The one or more occupancy networks implicitly represent 3D surfaces using a continuous decision boundary based on a deep neural network classifier, and decides based on a threshold whether data belongs inside or outside a 3D structure. The probability is determined based neighboring position classification information. The probability is used by an entropy encoder to define a code length of an occupancy code of points in 3D space. The one or more occupancy networks learn the function to recover a specific shape based on a sparse input. The function represents a set of classes, and an object is recovered based on an input. A size of the function is smaller than the bitstream.

In another aspect, a system comprises an encoder configured for: receiving a bitstream at one or more occupancy networks, determining a probability of a position in the bitstream being occupied with the one or more occupancy networks and generating a function based on the probability of positions being occupied and a decoder configured for: recovering an object based on the function and an input. The bitstream comprises voxels, points, meshes, or projected images of 3D objects. The bitstream comprises one or more samples of a 3D space to be used to generate a 3D object with the one or more occupancy networks. The probability is determined using machine learning to implement implicit neural functions. The one or more occupancy networks implicitly represent 3D surfaces using a continuous decision boundary based on a deep neural network classifier, and decides based on a threshold whether data belongs inside or outside a 3D structure. The probability is determined based neighboring position classification information. The probability is used by to define a code length of an occupancy code of points in 3D space. A size of the function is smaller than the bitstream.

### BRIEF DESCRIPTION OF THE DRAWINGS

FIG. 1 illustrates a diagram of occupancy networks according to some embodiments.

FIG. 2 illustrates a diagram of point cloud compression using occupancy networks according to some embodiments.

FIG. 3 illustrates a flowchart of a method of implementing point cloud compression using occupancy networks according to some embodiments.

FIG. 4 illustrates a block diagram of an exemplary computing device configured to implement the method of implementing point cloud compression using occupancy networks according to some embodiments.

### DETAILED DESCRIPTION OF THE PREFERRED EMBODIMENT

Methods, systems and devices for efficiently compressing point clouds using machine learning-based occupancy estimation methods are described herein.

A point cloud compression scheme uses occupancy networks as an implicit representation of the points. The implicit neural functions define an occupancy probability for points in 3D space. This probability is then used by an entropy encoder to define the code length of the occupancy code of points in 3D space.

The MPEG is currently concluding two standards for Point Cloud Compression (PCC). Point clouds are used to represent three-dimensional scenes and objects, and are composed by volumetric elements (voxels) described by their position in 3D space and attributes such as color, reflectance, material, transparency, time stamp and others. The planned outcome of the standardization activity is the Geometry-based Point Cloud Compression (G-PCC) and the Video-based Point Cloud Compression (V-PCC). More recently, machine learning-based point cloud compression architectures are being studied.

A sparse convolutional network exploits the spatial dependency between neighbors to estimate the occupancy of voxels by means of probabilities used for entropy coding or binary classification, depending if one wants to perform lossless or lossy compression, respectively. As an alternative to the proposal, the use of an occupancy network is described, which performs the same task by assigning to every location/position an occupancy probability between 0 and 1. However, the embodiments described herein are more general since the method is able to be applied to points, meshes or projected images of 3D objects, and is not limited to a voxel-based representation. Scalability is able to be provided by voxelizing the volumetric space at an initial resolution and evaluating the occupancy network for all points in a grid.

Occupancy networks have several applications. Their usage is a scalable, and a more generic point cloud compression scheme is novel. Occupancy networks enable efficient and flexible point cloud compression. Although based on occupancy estimation, sparse convolutional neural networks are typically limited to voxel-based representation. In addition to the voxel-based representation, occupancy networks are able to deal with points, meshes, or projected images of 3D objects, making them more flexible in terms of input signal representation. The probability of occupancy of positions is estimated using occupancy networks instead of sparse convolutional neural networks.

The occupancy network implicitly represents 3D surfaces using a continuous decision boundary based on a deep neural network classifier, and decides based on a boundary (threshold) whether a point belongs inside or outside a 3D structure (e.g., mesh). The occupancy network repetitively decides whether a point belongs inside or outside and by doing this, the occupancy network defines the surface of the volumetric representation. The occupancy network is used to determine the probability of a position in space being occupied. The occupancy network is able to be used to assist in compression as well.

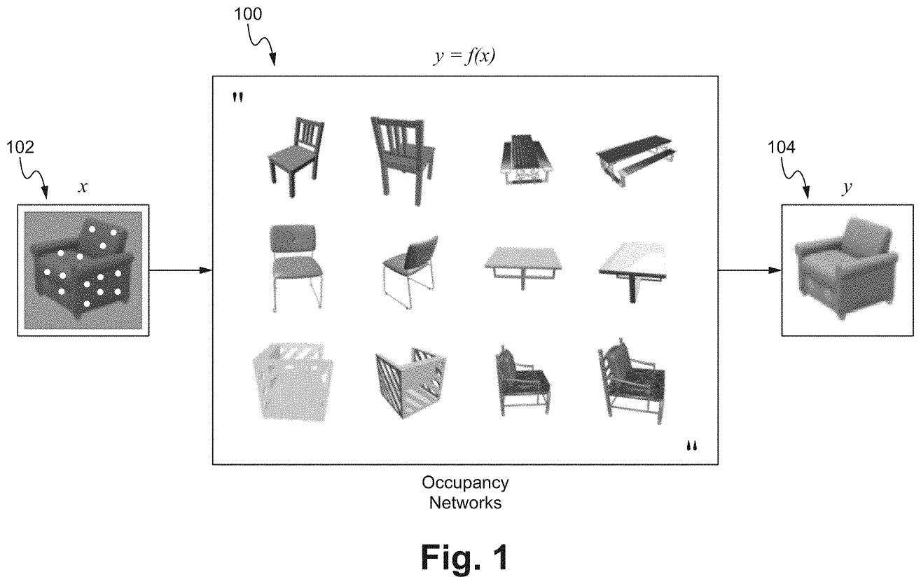

FIG. 1 illustrates a diagram of occupancy networks according to some embodiments. Occupancy networks learn general characteristics of classes of objects. In particular, occupancy maps learn a function that is able to recover a specific shape based on a sparse input. For example, an occupancy network 100 is able to represent chairs and tables. The occupancy network 100 is then able to receive a sparse representation of an object 102 (e.g., chair) as an input to the function and produce a representation 104 of the object in its original form with a desired precision (e.g., a more detailed object). In other words, a function receives a dataset of sparse points, and the function outputs an object similar to one of the classes the occupancy network function had learned. The precision of the function is not mathematically limited.

In addition to recovering the object from the sparse point cloud, efficient and flexible point cloud compression is able to be performed. The method is flexible because in addition to points, other forms of input are able to be used such as voxels, 2D images (projections) and meshes. The input data is able to be compressed regardless of the input form using occupancy estimation.

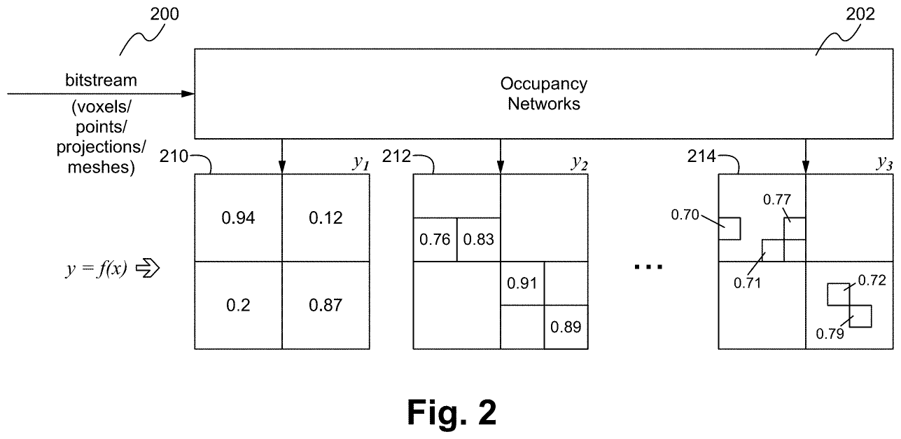

FIG. 2 illustrates a diagram of point cloud compression using occupancy networks according to some embodiments. A bitstream 200 is received at the occupancy networks 202. The bitstream 200 is able to be voxels, points, projections, meshes or others. The occupancy networks 202 are one or more neural networks able to obtain the implicit representation of a 3D object. The bitstream 200 is able to comprise network coefficients and/or random samples of a 3D space instead of a point cloud, and the occupancy networks 202 are able to generate a 3D object based on the network coefficients and random samples to check occupied positions in 3D space. Occupancy networks 202 progressively divide the space into smaller and smaller regions/divisions. For each division, the probability of positions being occupied is calculated. For example, the upper left region of the first block 210 has a 0.94 (or 94%) probability of having an occupied position. The first block 210 is able to be divided further into the more refined second block 212 which has smaller divisions. The blocks are able to be divided many more times, for example, to an n^{th} block 214 which has the smallest divisions, in the example. In the first block 210, the probabilities of a position being occupied are shown for all four blocks, although probabilities below a threshold (e.g., 0.50) indicate the position is not likely occupied. For the second block 212 and n^{th} block 214, if the probability for a region/division is less than a threshold, then the probability is not shown. The block is able to be divided theoretically infinitely (limited only by processing power and memory). By being able to divide the blocks many times, a system is able to be very scalable. For example, a system is able to output point clouds with different degrees of detail (e.g., coarse to fine detail).

The occupancy network assigns to every location an occupancy probability between 0 and 1. An occupancy network is used but not necessarily the full capacity of a neural network. For example, the surface of an object is generated based on the observation of that object (input conditioning). Furthering the example, a full, continuous surface of an object may not be generated, where only a certain level of detail is included. Scalability is provided in by voxelizing the volumetric space an initial resolution and evaluating the occupancy network for all points in the grid. Grid points p are marked as occupied if the evaluated value of the function at the point is bigger or equal to some threshold, which is given as a hyperparameter. In some embodiments, all voxel/points are marked as active, if at least two adjacent grid points have differing occupancy predictions.

The occupancy network is used to compress point clouds. The implicit 3D surface representation—not encoding the points themselves, rather a function is encoded. Unlike G-PCC, where the points are encoded directly in the geometry space, instead the function is encoded. The function is able to represent a set of classes, and then an object is able to be recovered based on an input. The object itself is not encoded; rather, the function is encoded. This is also referred to as an implicit 3D surface representation. In some embodiments, different aspects of an object are able to have different amounts of refinement (e.g., coarse to fine).

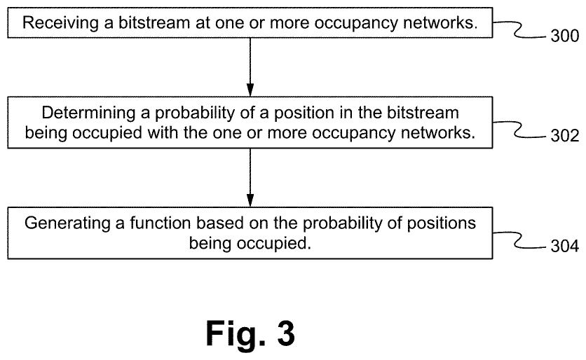

FIG. 3 illustrates a flowchart of a method of implementing point cloud compression using occupancy networks according to some embodiments. In the step 300, a bitstream is received at occupancy networks. The bitstream is able to include voxels, points, meshes, projected images of 3D objects or other data. In the step 302, the probability of a position being occupied in the bitstream is determined. The probability is determined in any manner such as based on machine learning (e.g., the implicit neural functions define an occupancy probability for points in 3D space) and/or classifications of the current object and previously classified objects. The occupancy network implicitly represents 3D surfaces using a continuous decision boundary based on a deep neural network classifier, and decides based on a boundary (threshold) whether a point belongs inside or outside a 3D structure (e.g., mesh). The occupancy network repetitively decides whether each point (or other data) belongs inside or outside and by doing this, the occupancy network defines the surface of the volumetric representation. The probability is also able to be determined based on current information (e.g., a position that has two neighboring positions with a high probability of being occupied is also able to have a high probability of being occupied). The probability is then used by an entropy encoder to define the code length of the occupancy code of points in 3D space. In the step 304, a function is generated based on the probability of positions being occupied. In particular, occupancy networks/maps learn a function that is able to recover a specific shape based on a sparse input. The occupancy network is then able to receive a sparse representation of an object (e.g., chair) as an input to the function and produce a representation of the object in its original form with a desired precision (e.g., a more detailed object). In other words, a function receives a dataset of sparse points, and the function outputs an object similar to one of the classes the occupancy network function had learned. The function is able to represent a set of classes, and then an object is able to be recovered based on an input. In some embodiments, the object itself is not encoded; rather, the function is encoded. This is also referred to as an implicit 3D surface representation. Since the function does not include all of the data points, the representation is a compressed version of the input bitstream. In some embodiments, fewer or additional steps are implemented. In some embodiments, the order of the steps is modified.

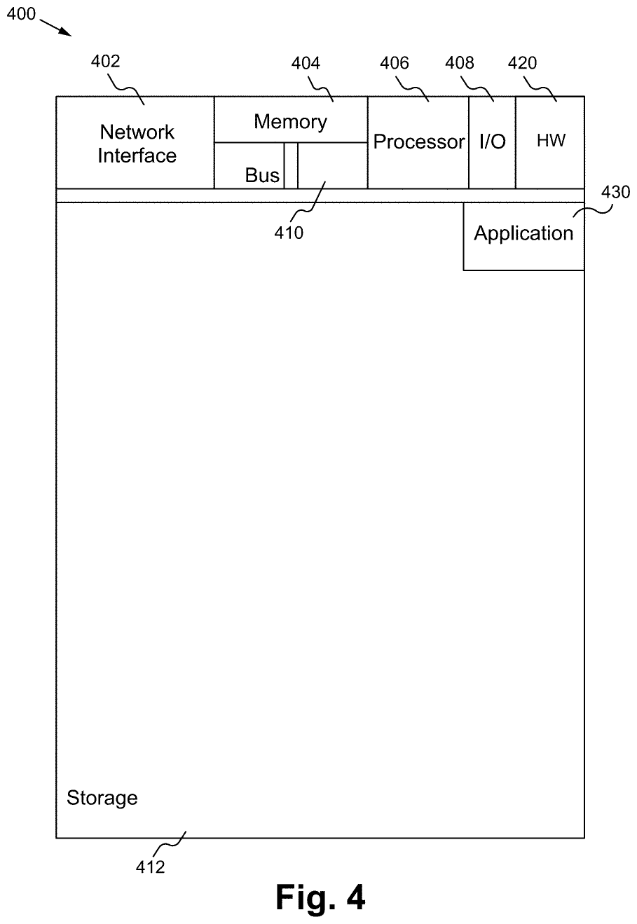

FIG. 4 illustrates a block diagram of an exemplary computing device configured to implement the method of implementing point cloud compression using occupancy networks according to some embodiments. The computing device 400 is able to be used to acquire, store, compute, process, communicate and/or display information such as images and videos including 3D content. The computing device 400 is able to implement any of the encoding/decoding aspects. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. Compression application(s) 430 used to implement the compression implementation are likely to be stored in the storage device 412 and memory 404 and processed as applications are typically processed. More or fewer components shown in FIG. 4 are able to be included in the computing device 400. In some embodiments, compression hardware 420 is included. Although the computing device 400 in FIG. 4 includes applications 430 and hardware 420 for the compression method, the compression method is able to be implemented on a computing device in hardware, firmware, software or any combination thereof. For example, in some embodiments, the compression applications 430 are programmed in a memory and executed using a processor. In another example, in some embodiments, the compression hardware 420 is programmed hardware logic including gates specifically designed to implement the compression method.

In some embodiments, the compression application(s) 430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the compression method, a device acquires or receives 3D content (e.g., point cloud content). The compression method is able to be implemented with user assistance or automatically without user involvement.

In operation, the compression method enables more efficient and more accurate 3D content encoding compared to previous implementations. The compression method is highly scalable as well.

### Some Embodiments of Point Cloud Compression Using Occupancy Networks

1. A method programmed in a non-transitory memory of a device comprising:
   receiving a bitstream at one or more occupancy networks;
   determining a probability of a position in the bitstream being occupied with the one or more occupancy networks; and
   generating a function based on the probability of positions being occupied.
2. The method of clause 1 wherein the bitstream comprises voxels, points, meshes, or projected images of 3D objects.
3. The method of clause 1 wherein the bitstream comprises one or more samples of a 3D space to be used to generate a 3D object with the one or more occupancy networks.
4. The method of clause 1 wherein the probability is determined using machine learning to implement implicit neural functions.
5. The method of clause 1 wherein the one or more occupancy networks implicitly represent 3D surfaces using a continuous decision boundary based on a deep neural network classifier, and decides based on a threshold whether data belongs inside or outside a 3D structure.
6. The method of clause 1 wherein the probability is determined based neighboring position classification information.
7. The method of clause 1 wherein the probability is used by an entropy encoder to define a code length of an occupancy code of points in 3D space.
8. The method of clause 1 wherein the one or more occupancy networks learn the function to recover a specific shape based on a sparse input.
9. The method of clause 1 wherein the function represents a set of classes, and an object is recovered based on an input.
10. The method of clause 1 wherein a size of the function is smaller than the bitstream.
11. An apparatus comprising:
   a non-transitory memory for storing an application, the application for:
      receiving a bitstream at one or more occupancy networks;
      determining a probability of a position in the bitstream being occupied with the one or more occupancy networks; and
      generating a function based on the probability of positions being occupied; and
   a processor coupled to the memory, the processor configured for processing the application.
12. The apparatus of clause 11 wherein the bitstream comprises voxels, points, meshes, or projected images of 3D objects.
13. The apparatus of clause 11 wherein the bitstream comprises one or more samples of a 3D space to be used to generate a 3D object with the one or more occupancy networks.
14. The apparatus of clause 11 wherein the probability is determined using machine learning to implement implicit neural functions.
15. The apparatus of clause 11 wherein the one or more occupancy networks implicitly represent 3D surfaces using a continuous decision boundary based on a deep neural network classifier, and decides based on a threshold whether data belongs inside or outside a 3D structure.
16. The apparatus of clause 11 wherein the probability is determined based neighboring position classification information.
17. The apparatus of clause 11 wherein the probability is used by an entropy encoder to define a code length of an occupancy code of points in 3D space.
18. The apparatus of clause 11 wherein the one or more occupancy networks learn the function to recover a specific shape based on a sparse input.
19. The apparatus of clause 11 wherein the function represents a set of classes, and an object is recovered based on an input.
20. The apparatus of clause 11 wherein a size of the function is smaller than the bitstream.
21. A system comprising:
   an encoder configured for:
      receiving a bitstream at one or more occupancy networks;
      determining a probability of a position in the bitstream being occupied with the one or more occupancy networks; and
      generating a function based on the probability of positions being occupied; and
   a decoder configured for:
      recovering an object based on the function and an input.
22. The system of clause 21 wherein the bitstream comprises voxels, points, meshes, or projected images of 3D objects.
23. The system of clause 21 wherein the bitstream comprises one or more samples of a 3D space to be used to generate a 3D object with the one or more occupancy networks.
24. The system of clause 21 wherein the probability is determined using machine learning to implement implicit neural functions.
25. The system of clause 21 wherein the one or more occupancy networks implicitly represent 3D surfaces using a continuous decision boundary based on a deep neural network classifier, and decides based on a threshold whether data belongs inside or outside a 3D structure.
26. The system of clause 21 wherein the probability is determined based neighboring position classification information.
27. The system of clause 21 wherein the probability is used by to define a code length of an occupancy code of points in 3D space.
28. The system of clause 21 wherein a size of the function is smaller than the bitstream.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
receiving a bitstream at one or more occupancy networks;
determining a probability of a position in the bitstream being occupied with the one or more occupancy networks; and
generating a function based on the probability of positions being occupied.

2. The method of claim 1 wherein the bitstream comprises voxels, points, meshes, or projected images of 3D objects.

3. The method of claim 1 wherein the bitstream comprises one or more samples of a 3D space to be used to generate a 3D object with the one or more occupancy networks.

4. The method of claim 1 wherein the probability is determined using machine learning to implement implicit neural functions.

5. The method of claim 1 wherein the one or more occupancy networks implicitly represent 3D surfaces using a continuous decision boundary based on a deep neural network classifier, and decides based on a threshold whether data belongs inside or outside a 3D structure.

6. The method of claim 1 wherein the probability is determined based neighboring position classification information.

7. The method of claim 1 wherein the probability is used by an entropy encoder to define a code length of an occupancy code of points in 3D space.

8. The method of claim 1 wherein the one or more occupancy networks learn the function to recover a specific shape based on a sparse input.

9. The method of claim 1 wherein the function represents a set of classes, and an object is recovered based on an input.

10. The method of claim 1 wherein a size of the function is smaller than the bitstream.

11. An apparatus comprising:
a non-transitory memory for storing an application, the application for:
receiving a bitstream at one or more occupancy networks;
determining a probability of a position in the bitstream being occupied with the one or more occupancy networks; and
generating a function based on the probability of positions being occupied; and
a processor coupled to the memory, the processor configured for processing the application.

12. The apparatus of claim 11 wherein the bitstream comprises voxels, points, meshes, or projected images of 3D objects.

13. The apparatus of claim 11 wherein the bitstream comprises one or more samples of a 3D space to be used to generate a 3D object with the one or more occupancy networks.

14. The apparatus of claim 11 wherein the probability is determined using machine learning to implement implicit neural functions.

15. The apparatus of claim 11 wherein the one or more occupancy networks implicitly represent 3D surfaces using a continuous decision boundary based on a deep neural network classifier, and decides based on a threshold whether data belongs inside or outside a 3D structure.

16. The apparatus of claim 11 wherein the probability is determined based neighboring position classification information.

17. The apparatus of claim 11 wherein the probability is used by an entropy encoder to define a code length of an occupancy code of points in 3D space.

18. The apparatus of claim 11 wherein the one or more occupancy networks learn the function to recover a specific shape based on a sparse input.

19. The apparatus of claim 11 wherein the function represents a set of classes, and an object is recovered based on an input.

20. The apparatus of claim 11 wherein a size of the function is smaller than the bitstream.

21. A system comprising:
an encoder configured for:
receiving a bitstream at one or more occupancy networks;
determining a probability of a position in the bitstream being occupied with the one or more occupancy networks; and
generating a function based on the probability of positions being occupied; and
a decoder configured for:
recovering an object based on the function and an input.

22. The system of claim 21 wherein the bitstream comprises voxels, points, meshes, or projected images of 3D objects.

23. The system of claim 21 wherein the bitstream comprises one or more samples of a 3D space to be used to generate a 3D object with the one or more occupancy networks.

24. The system of claim 21 wherein the probability is determined using machine learning to implement implicit neural functions.

25. The system of claim 21 wherein the one or more occupancy networks implicitly represent 3D surfaces using a continuous decision boundary based on a deep neural network classifier, and decides based on a threshold whether data belongs inside or outside a 3D structure.

26. The system of claim 21 wherein the probability is determined based neighboring position classification information.

27. The system of claim 21 wherein the probability is used by to define a code length of an occupancy code of points in 3D space.

28. The system of claim 21 wherein a size of the function is smaller than the bitstream.
